(19) United States
(12) Patent Application Publication
(10) Pub. No.: US 2019/0196669 A1
(43) Pub. Date: Jun. 27, 2019

(54) INTERACTIVE USER INTERFACE IMPROVED BY PRESENTATION OF APPROPRIATE INFORMATIVE CONTENT

(71) Applicant: ORANGE, Paris (FR)

(72) Inventor: Julien Riera, Chatillon Cedex (FR)

(21) Appl. No.: 16/228,990

(22) Filed: Dec. 21, 2018

(30) Foreign Application Priority Data
Dec. 26, 2017 (FR) 1763223

(51) Int. Cl. G06F 3/0482; G06F 9/451; G06F 3/0488; G06F 3/041; H04L 12/58

(52) U.S. Cl. CPC G06F 3/0482; G06F 9/453; H04L 51/02; G06F 3/0412; G06F 3/04883

(57) ABSTRACT

A user interface and method operating according to a conversational menu with interaction between a user and a device. The conversational menu includes at least one question and answer heading corresponding to a question posed to the user via the interface and waiting for an answer from the user via the interface. the method includes: combining with this question-and-answer heading at least one informative content to help the user, related to the question-and-answer heading; and during execution of the question-and-answer heading: detecting receiving through the interface a user help request signal with predefined form; and, as needed providing the user through the interface the informative content before waiting for the user's response.

### FIELD OF THE DISCLOSURE

The invention relates to the management of a computer device with user interface operating according to a conversational menu with interaction between the user and the device thereof.

### BACKGROUND OF THE DISCLOSURE

The conversational interaction between humans and computer devices is expanding. The conversational agent (or “chat-bot”) is better and better able to guide the user in their interaction with a computer service. These chat-bots provide the user a text (and/or voice) interaction. These chat-bots often give the user a choice among several possibilities in order to continue the exchange.

With these chat-bots, the user can interface with various types of uses and therefore services, in particular with various types of data presentation that the user asked for. It is possible that the choices offered by the device are not clear to the user.

The user may ask for explanations which lead to a conversation, most often written, with the chat-bot about their various options.

A problem that results is that the conversation enters into a new conversational flow and takes the user away from the initial step needing their choice. The user feels that this new conversation comes to “pollute” a logical conversational flow.

Another problem is that the interface asks the user to return to a written interaction type for one or more of the choices offered. This contributes to unpleasantness for the user.

### SUMMARY

One or more exemplary embodiments of the present invention seeks to improve this situation.

For this purpose, an exemplary embodiment provides a method implemented by a computer device comprising a user interface operating according to a conversational menu with interaction between the user and the device, where the conversational menu comprises at least one question and answer heading corresponding to a question posed to the user via the interface and waiting for an answer from the user via the interface. In particular, the method comprises:
Combining with said question-and-answer heading at least one informative content to help the user, related to said question-and-answer heading; and
During the execution of said question-and-answer heading:
   Detecting receiving through the interface a user help request signal with predefined form;
   And, upon receiving a user help request provide the user through the interface said informative content before waiting for the user's response.

Thus, according to one of the advantages that an exemplary embodiment of the present invention provides, the user can interrupt the menu and request an explanatory informative content before making their choice, in order to better understand what the interface can propose in response to the user's choice. The user saves considerable conversational interaction time with the interface and directly accesses the form for data which really suits their choice.

In one implementation, the expected response from the user relates to a choice through the interface among a plurality of data presentation types, and the aforementioned informative content illustrates at least one data presentation sample for at least a portion of the types of said plurality of presentation types.

Typically a data presentation sample can advantageously be provided per possible choice by the user, who can then navigate from one presentation sample to another and finally choose the presentation form which best suits them for the data that they actually requested through the interface.

In one embodiment where the user interface comprises a graphical interface, it can be provided that:
The graphical interface, during execution of the question-and-answer heading, displays a plurality of buttons each selectable by the user, where each button corresponds to a possible data presentation choice among the plurality of presentation types;

And the method can then comprise:
Combining informative content illustrating a data presentation sample among said plurality of data presentation types with each button; and
During display of the buttons:
   Detecting receiving through the interface a user help request signal with predefined form, connected with one of the buttons selected by the user;
   And, upon receiving a help request from the user, display on the graphical interface the informative content showing at least one data presentation sample according to the presentation type corresponding to the button selected by the user.

Thus, the user can directly view the presentation samples offered to them by the interface. It can involve prerecorded examples and not require a long processing time before display thereof. It can also involve information already presented to the user in the past and stored in memory for display as examples of these data presentations already known to the user. The user can thus choose the presentation which seems most appropriate to them in connection with their expectations.

In an implementation where the graphical interface is touch type, a long press on one of the buttons selected by the user can generate said predefined signal connected with this selected button, and thus cause the display of the informative content corresponding to this selected button, whereas a short press on the selected button can cause the display of a data presentation requested by the user through the conversational menu, according to the type of presentation corresponding to the selected button.

Thus, using a single button placement it is intuitively possible to preview a presentation sample associated with the button (long press), and quickly select it if it suits the user (short press).

In one implementation, the interface indicates the availability of at least one data presentation sample by a predefined signal, so the user can possibly try the aforementioned example before making a response.

With this indication, the user can thus know that an example is available and can, for example, quickly view it, if they wish.

In one implementation, the informative content proposal to the user through the interface is done outside of a current conversational menu between the user and the device.

For example, in the case where the user interface comprises a graphical interface, the informative content can be displayed overlaying the messages exchanged during an interaction in progress between the user and the device.

Such an implementation is shown for example in FIG. 2B (discussed in detail later) where it can be seen that presentation of the content is displayed (in the gray box), but can next disappear following the exchange of messages “PROP”, “CHOI?”, etc. (shown on a white background in contrast to the gray box).

The advantages of such an implementation and in particular of such an overlay are especially:
the informative content display can be closed once the user has made the response and thus the informative content no longer appears on the graphical interface display during the current conversation between the user and the device: pollution of the current conversation is thus reduced;
the informative content does not need to be recorded in the conversation history: the pollution of conversation histories is then reduced.

In an embodiment, the conversational menu is executed in the context of a chat-bot type application.

Such an application is advantageous to the extent where, in this type of application, most of the messages are exchanged in writing. Thus, a help system by presentation of examples improves the quality of the interface and limits the number of exchanges of messages that the user has to write. However, of course, application variants are possible and the presentation of an informative content, such as a sample data presentation, can in reality occur in any type of user interface, broadly understood.

An exemplary embodiment of the present invention targets a computer device with a user interface operating according to a conversational menu with interaction between the user and the device, where the device comprises in particular a processing circuit for practicing the preceding method. An implementation example of such a processing circuit is shown in FIG. 7 discussed below.

An exemplary embodiment of the present invention also targets a computer program comprising instructions for practicing the above method when these instructions are executed by a processor. The sample general algorithm for such a computer program is shown in FIG. 6, discussed below.

### BRIEF DESCRIPTION OF THE DRAWINGS

Additionally, other advantages and characteristics of one or more embodiment of the invention will appear upon reading the following description and implementation examples given without limitation, and upon examining the attached drawings, on which:

FIG. 1 shows schematically a graphical interface on which the user is offered a choice among three types of data presentation P3, P4 and P5;

FIG. 2A shows schematically the graphical interface from FIG. 1 after the user selects a data presentation sample to be displayed from among the three possible data visualization samples;

FIG. 2B schematically shows an alternative to the graphical interface form from FIG. 2A;

FIG. 3 shows schematically the graphical interface from FIG. 1 after the user selects a data presentation sample, other than the one shown in FIGS. 2A and 2B;

FIG. 4 schematically shows the graphical interface from FIG. 3 with the possibility of returning to the previous menu (screen on right of FIG. 4);

FIG. 5 shows an embodiment in which the graphical interface has buttons P0 showing the user that a sample presentation to be displayed is available, if the user wants it;

FIG. 6 summarizes the various steps of the method according to an example of implementation of the invention;

FIG. 7 shows a processing circuit for a device according to an example of implementation of the invention, for practicing the above method.

### DETAILED DESCRIPTION OF ILLUSTRATIVE EMBODIMENTS

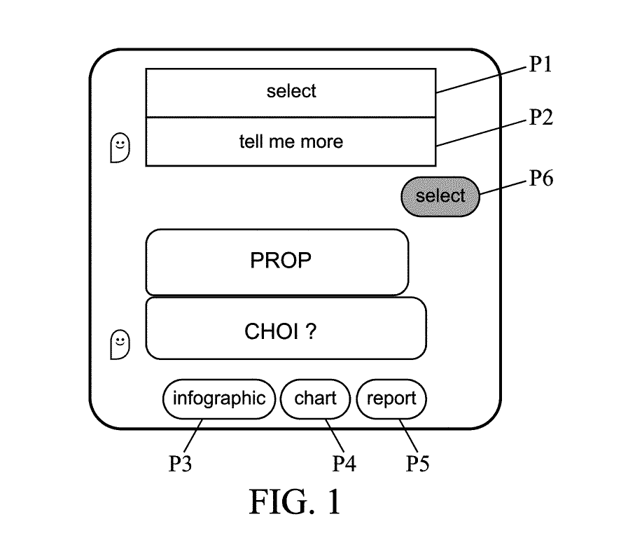

Referring first to FIG. 1 the interface displays a proposal message PROP to the user such as for example “Do you want the respective proportions of the activity by department for your company over the past year?”. If the user is in fact interested in this proposal PROP, here the graphic interface is tactile, the user presses on the area “select” referenced P1 on FIG. 1. On the other hand, if the user wishes first to know more about the kind of data which will be displayed for them, the user can press on the area P2: “tell me more” in which case an interactive conversation can start with the interface for explaining what data could be shown, etc., according to a conventional form of the prior art.

But in particular here, if the user presses on the area P1 for selecting the proposal PROP from the interface (selection of the proposal PROP by the user leads to the dialogue bubble “select” referenced P6), the interface then proposes several possible choices to the user for presentation of these data (message CHOI? addressed to the user), for example:
Infographic form (choice selectable with button P3),
Or histogram form (choice selectable with button P4),
Or even in detailed activity report form with text and graphics, for example (choice selectable with button P5).

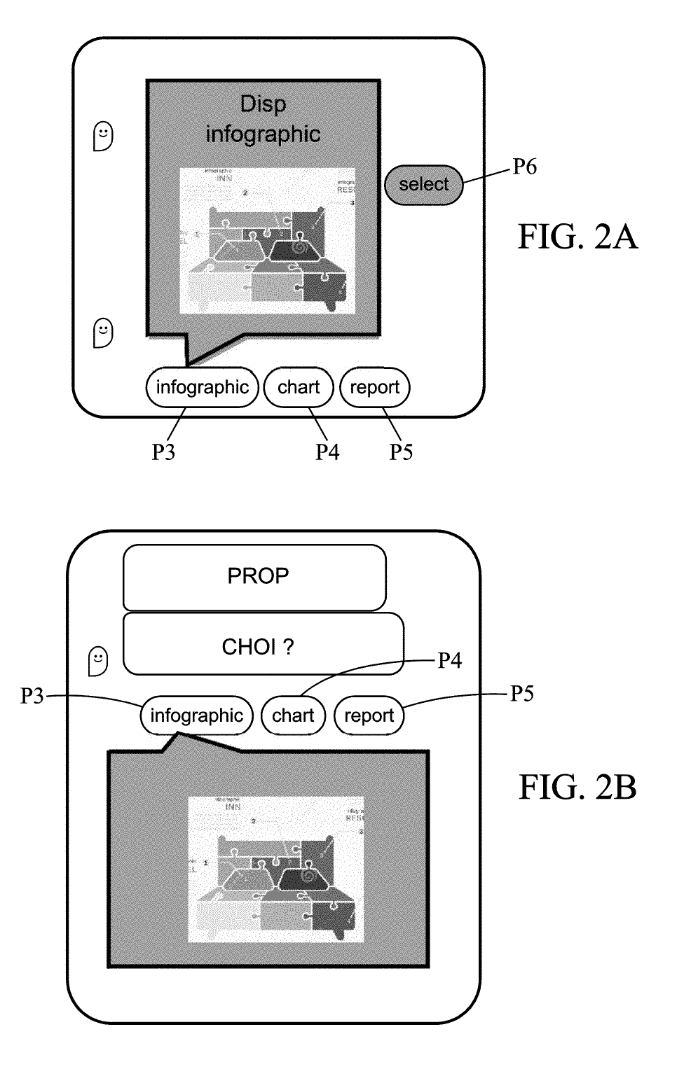

According to an exemplary aspect of the invention, the user can then require display of an example here for each choice. For this purpose, a predefined signal corresponding to a long press on the touch interface, for example on the button P3, causes the display of a sample infographic representation as shown on FIG. 2A. In the example shown in FIG. 2A, the presentation takes the full screen, whereas in the example from FIG. 2B, the size of the presentation is reduced and allows the most recent messages between the user and their interface to be seen.

On the other hand, a short press on button P3 causes the selection of this form for presentation of the data requested by the user.

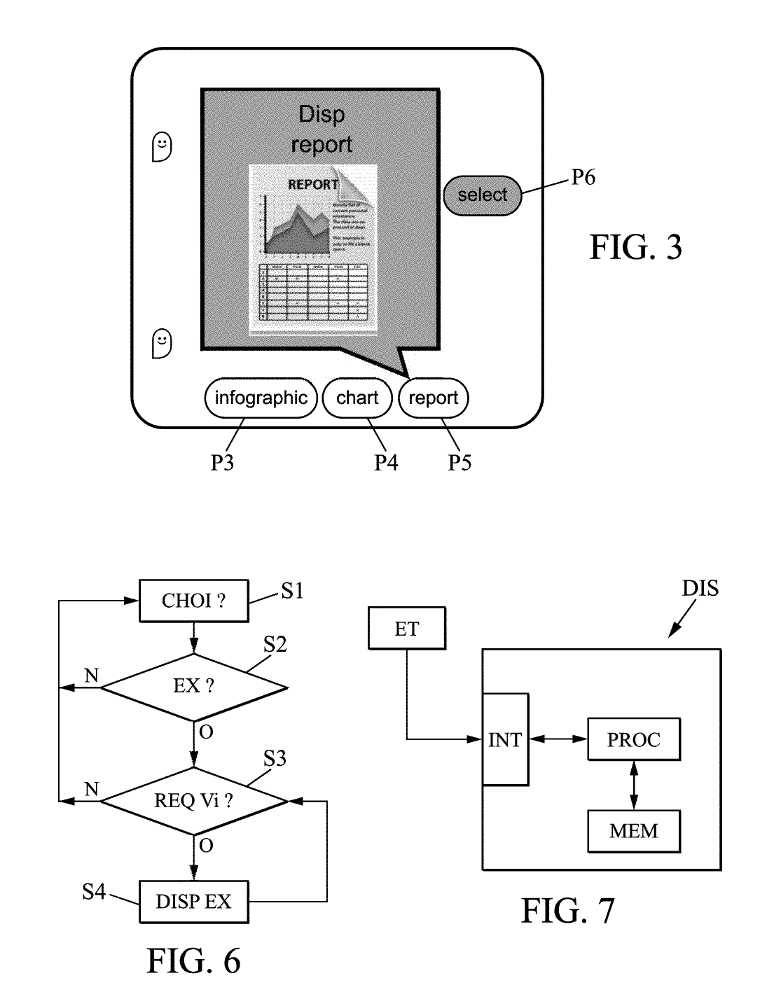

If, additionally, the user wishes to test the “activity report” type presentation form, the user can make a long press on the button P5 and thus get the example of a presentation according to an activity report, such as shown on FIG. 3.

If the user prefers this presentation form according to FIG. 3 over that shown on one of FIGS. 2A and 2B, the user can make a short press on the button P5 and then get the presentation of the data that they wish according to the form from FIG. 3.

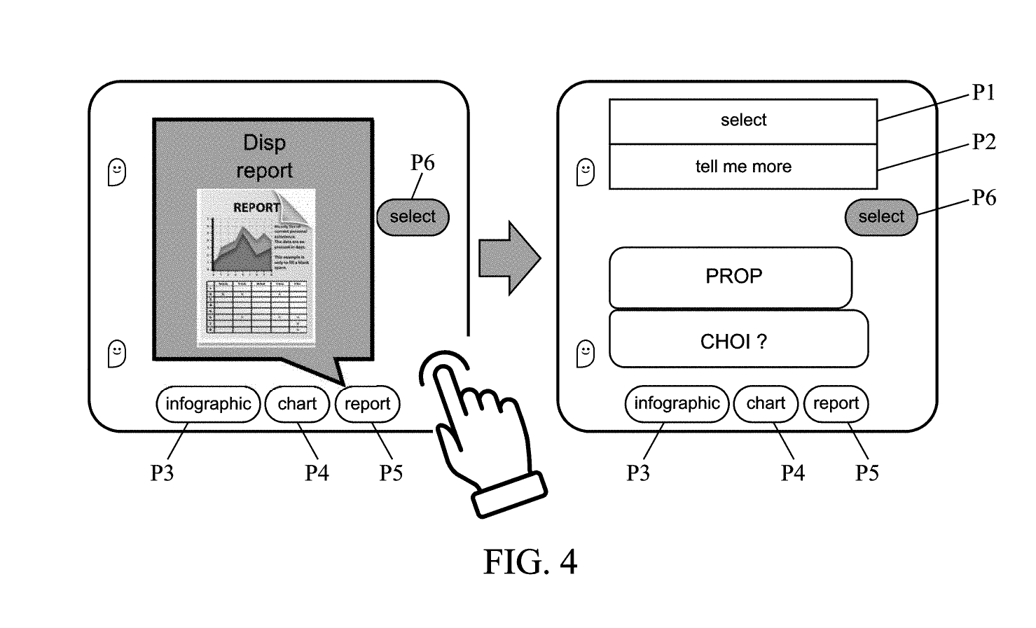

If instead, the user does not want the presentation form from FIG. 3 and returns to the presentation choices to be selected, referring to FIG. 4, the user can touch the touch screen in any zone of the current display presentation outside of the confirmation button P5, and thereby return to the initial screen page corresponding to FIG. 1.

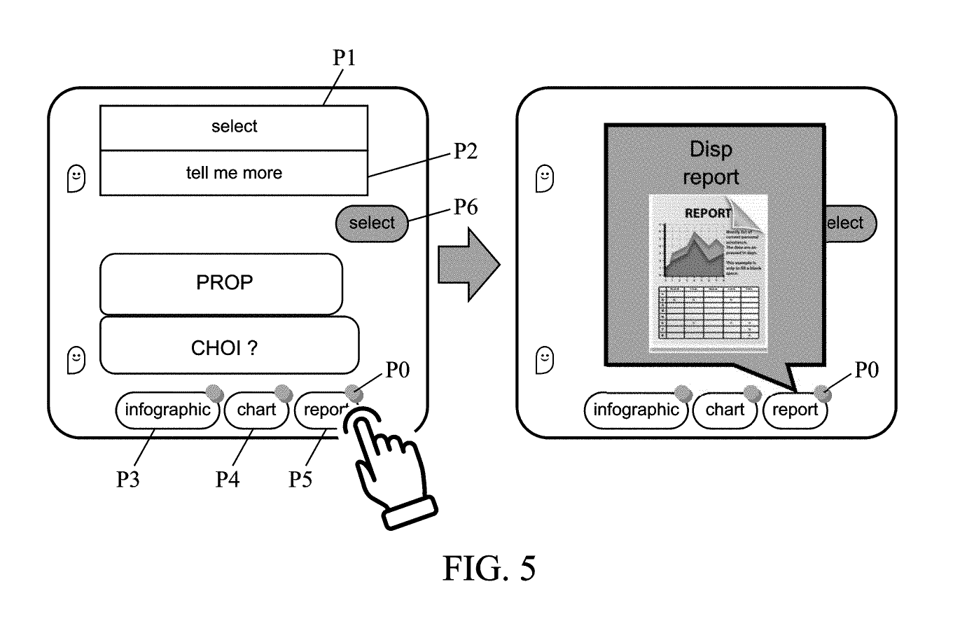

Referring to FIG. 5, in this embodiment, displaying lozenge shapes P0 in the example shown is proposed for indicating the availability of data presentation samples for the user, which can be viewed before finally choosing the presentation that the user wants for the requested data.

Now referring to FIG. 6, in step S1 the user is asked to make a choice in the scrolling of the conversational interactive menu. In the case where presentation type samples, for presenting data relative to this choice, are available to be shown to the user (arrow 0 leaving test S2), the interface device waits in step S3 for a request by the user to display a presentation sample. If the user interacts with the interface so as to view a specific presentation sample (arrow 0 leaving test S3), the presentation sample selected by the user is displayed by the interface in step S4, and then the interface device again waits for a possible request for display of another presentation sample in step S3. If, instead, the user does not wish to view a sample (arrow N leaving test S3), the interface device returns to step S1 waiting for a user choice. Of course, if no sample is available for viewing by the user (arrow N leaving test S2), the interface device continues to wait for a choice from the user instep S1.

Now refer to FIG. 7, here an interface device DIS has a touchscreen ET connected to a processing circuit typically comprising:
A memory MEM for storing at least computer program instruction data in the meaning of an exemplary embodiment of the invention, FIG. 6 then showing a general algorithm for such a computer program;
A processor PROC connected to the memory MEM for reading these instruction data from the memory MEM and executing the aforementioned computer program, thus performing the steps of the method presented above; and
A communication interface INT between the touchscreen ET and the processor PROC for receiving entries from the touchscreen and sending data to be displayed on the touchscreen.

Typically, the memory MEM can further store content data such as data for presentation type examples, as shown above with reference to FIGS. 1 to 5.

Thus, according to one of the advantages of an exemplary embodiment of the present invention, at least under one of these embodiments, the user can request an explanation of the choice proposed in step S1, and can do this without going through a new conversational interaction (which can be as burdensome as it is written in the example of implementation of a touch interface). By practicing an exemplary embodiment of the invention, the user can save time and go from one explanation to another more easily.

Of course, the present invention is not limited to embodiments described above as examples; it extends to other variants.

Thus, it will be understood that the interface can be graphic or touch type as in the implementation examples above. Just the same, a voice interaction can be conceived in the same way, with presentation of voice content samples.

In the above example referring to FIGS. 1 to 5, if the user makes a long press then a graphical element appears above (FIG. 2A) or below (FIG. 2B) or possibly in the flow of conversation, by providing clarification and or additional information on the user's choice element. Of course, despite the exhaustiveness of the implementation examples presented above, other graphic arrangements and presentations of the functions associated with these sample presentations can be anticipated.

Further, these examples and the clarification or additional information that they provide can be of different kinds. It can be informative written content, or other multimedia elements (graphics, animated graphics including video seen on a live or recorded video flow, application elements—with for example the possibility of entering a password before accessing a second level of information, or displaying a video flow from the device by adding an overlay of information thereto, or other).

Further, with reference to FIG. 4, once the user presses on the interface (except on the interactive element P5 of this “contextual help”) than the help element disappears, and the action proposed by the button P5 actuating the corresponding choice (reviewing the data requested according to the “REPORT” choice) is not launched. As a variant, a button can be provided as such for returning to the previous menu step. Further, the device waits for the user to press on one of the choices P3 to P5 with a long or short press as previously explained. However, there again, alternatives are possible in the form of the signal according to a short or long press, like for example one effectively long press (forgetting more information on the choice elements) and two short presses for the selection.

Additionally, as was presented above with reference to FIG. 5, an embodiment in which interface buttons (the large images P0) identify elements for which informative content is available in order to make the use thereof easier and to not leave it up to the user to look for which interactive menu elements have an associated informative content. As a variant to a presentation in the form of a lozenge (logo or other), another distinctive graphical element can be provided such as underlining of text, a different color, or other.

Although the present disclosure has been described with reference to one or more examples, workers skilled in the art will recognize that changes may be made in form and detail without departing from the scope of the disclosure and/or the appended claims.

1. A method implemented by a computer device comprising a user interface operating according to a conversational menu with interaction between a user and the computer device, where the conversational menu comprises at least one question and answer heading corresponding to a question posed to the user via the interface and waiting for an answer from the user via the interface,
the method comprising:
combining with said question-and-answer heading at least one informative content to help the user, related to said question-and-answer heading; and
during execution of said question-and-answer heading:
detecting receiving through the interface a user help request signal with predefined form;
and, upon receiving a user help request providing the user through said interface informative content before putting the user's response on hold.

2. The method according to claim 1, wherein the expected response from the user relates to a choice through the interface among a plurality of data presentation types, and said informative content illustrates at least one data presentation sample for at least a portion of the types of said plurality of presentation types.

3. The method according to claim 2, wherein:
said graphical interface, during execution of the question-and-answer heading, displays a plurality of buttons each selectable by the user,
each button corresponds to a possible data presentation choice among the plurality of presentation types;
the method comprising:
combining informative content illustrating a data presentation sample among said plurality of data presentation types with each button; and
during display of the buttons:
detecting receiving through the interface a user help request signal with predefined form, connected with one of the buttons selected by the user;
and, upon receiving a help request from the user, display on the graphical interface the informative content showing at least one data presentation sample according to the presentation type corresponding to the button selected by the user.

4. The method according to claim 3, wherein the graphical interface is touch type and a long press on one of the buttons selected by the user generates said predefined signal connected with this selected button, and causes the display of the informative content corresponding to this selected button, whereas a short press on the selected button causes the display of a data presentation requested by the user through the conversational menu, according to the type of presentation corresponding to the selected button.

5. The method according to claim 2, wherein the interface indicates the availability of at least one data presentation sample by a predefined signal, so the user can possibly try said example before making a response.

6. The method according to claim 1, wherein the informative content proposal to the user through the interface is done outside of a current conversational menu between the user and the device.

7. The method according to claim 6, wherein since the user interface comprises a graphical interface, the informative content is displayed overlaying the messages exchanged during an interaction in progress between the user and the device.

8. The method according to claim 1, wherein the conversational menu is executed in the context of a chat-bot type application.

9. A computer device comprising:
a user interface operating according to a conversational menu with interaction between a user and the computer device where the conversational menu comprises at least one question and answer heading corresponding to a question posed to the user via the interface and waiting for an answer from the user via the interface; and
a processing circuit configured to:
combine with said question-and-answer heading at least one informative content to help the user, related to said question-and-answer heading; and
during execution of said question-and-answer heading:
detect receiving through the interface a user help request signal with predefined form;
and, upon receiving a user help request, provide the user through said interface informative content before putting the user's response on hold.

10. A non-transitory computer-readable medium comprising a computer program stored thereon comprising instructions implementing a method when these instructions are executed by a processor of a computer device, wherein the computer device comprises a user interface operating according to a conversational menu with interaction between a user and the computer device, where the conversational menu comprises at least one question and answer heading corresponding to a question posed to the user via the interface and waiting for an answer from the user via the interface, and wherein the method comprises:
combining with said question-and-answer heading at least one informative content to help the user, related to said question-and-answer heading; and
during execution of said question-and-answer heading:
detecting receiving through the interface a user help request signal with predefined form;
and, upon receiving a user help request providing the user through said interface informative content before putting the user's response on hold.
